(19) United States
(12) Patent Application Publication
(10) Pub. No.: US 2018/0285839 A1
(43) Pub. Date: Oct. 4, 2018

(54) PROVIDING DATA PROVENANCE, PERMISSIONING, COMPLIANCE, AND ACCESS CONTROL FOR DATA STORAGE SYSTEMS USING AN IMMUTABLE LEDGER OVERLAY NETWORK

(71) Applicant: Datient, Inc., Sunnyvale, CA (US)

(72) Inventors: Danny Yang, Santa Clara, CA (US); Mohamad El Balaa, Redwood City, CA (US); Rudi Cilibrasi, Walnut Creek, CA (US); Shihao Guo, Mountain View, CA (US)

(21) Appl. No.: 15/588,542

(22) Filed: May 5, 2017

Related U.S. Application Data
(60) Provisional application No. 62/481,563, filed on Apr. 4, 2017.

(51) Int. Cl. G06Q 20/06; H04L 9/06; H04L 9/32; G06Q 20/40; G06Q 20/38

(52) U.S. Cl. CPC G06Q 20/0655; H04L 9/0637; H04L 9/32; G06Q 2220/00; G06Q 20/3829; H04L 2209/56; G06Q 20/40

(57) ABSTRACT

A data management system is disclosed for data provenance and data storage that allows multiple independent parties (who may not trust each other) to securely share data, track data provenance, maintain audit logs, keep data synchronized, comply with regulations, and handle permissioning and control who can access the data. The system leverages security guarantees derived from the computer systems already trusted to control billions of dollars of Bitcoin and Ethereum cryptocurrencies to create a secure and completely auditable system of document tracking that can be shared among untrusted parties over a computer network. Certain instances work both with public blockchains like Bitcoin and Ethereum and with private blockchains.

### CROSS-REFERENCE TO RELATED APPLICATION

This application claims benefit of U.S. Provisional Patent Application Ser. No. 62/481,563, filed Apr. 4, 2017, the subject matter thereof is incorporated by reference in its entirety.

### TECHNICAL FIELD

This disclosure relates to data permissioning, access control, compliance, and sharing. More particularly, the disclosure relates to managing these interests with immutable cryptocurrency ledgers.

### BACKGROUND

The world of “Big Data” is full of many entities that do not particularly trust one another and compete directly but still benefit from mutual sharing of data. One such example of mutual benefit through data sharing is in the training of machine learning or AI modules. Machine learning applications improve with additional training data; thus, sharing of training data between parties improves the overall function of these modules. Despite the clear mutual benefit, where the parties do not have reason to trust one another, precautions must be taken.

### BRIEF DESCRIPTION OF THE DRAWINGS

FIG. 1 is an illustrative block diagram of a single-entity system architecture.

FIG. 2 is an illustrative block diagram of a dual-entity system architecture.

FIG. 3 is an illustrative block diagram of a multi-entity system architecture with a single data store.

FIG. 4 is an illustrative block diagram of a multi-entity system architecture with multiple data stores.

FIG. 5 is a flowchart illustrating control nodes facilitating data requests.

FIG. 6 is a flowchart illustrating blockchain hybridization.

FIG. 7 is a block diagram illustrating an example of a computing system in which at least some operations described herein can be implemented.

### DETAILED DESCRIPTION

Disclosed herein is a technique to make use of an immutable cryptocurrency ledger to record permissions, control, and actions within a data store by multiple parties. Data stores referred to herein include examples such as a server database or a filesystem, similar to a Windows, OSX or POSIX (unix) machine. Additional examples include cloud drives, such as Google Drive, Amazon Web Services (AWS) S3, or other cloud data stores. The system further supports Filesystem in Userspace (FUSE) such that one can mount a drive and interact with the filesystem in Windows or OSX and get data provenance and access control permissions as well. To keep track of the events in a given data store, event metadata is embedded into a cryptocurrency ledger.

Embedding data in a cryptocurrency ledger, such as the Bitcoin blockchain, is used in many cryptocurrency applications. Every cryptocurrency transaction contains input(s) and output(s). Cryptocurrencies allow an output to contain arbitrary data, simultaneously identifying that it is not a spendable output (not cryptocurrency being transferred for a later redemption). The arbitrary data may be a hashed code that contains a significant amount of data. As long as the submitted transaction is a valid transaction, that transaction (“encoded transaction”) will be propagated through the network and mined into a block. This allows data to be stored with many of the same benefits that secure the cryptocurrency.

Once data is stored in the cryptocurrency ledger (especially on the Bitcoin main chain), it is exceedingly difficult to remove or alter that data. In this sense, a cryptocurrency ledger is immutable. In order to make changes to posted blocks to the Bitcoin blockchain, one must control 75% of the nodes. Because the number of Bitcoin nodes is in the thousands, the Bitcoin blockchain is effectively immutable. In some embodiments, and in privately controlled cryptocurrencies, the records stored on the respective ledgers are more susceptible to hijack or take over as a result that nodes are less numerous. However, the risk is low, and properly administered cryptocurrency ledgers, be they public or private, are considered immutable.

The resulting effect is that whoever creates the transaction with the data can prove that they created it, because they hold the private key used to sign the transaction. Additionally, they can prove the approximate time and date the data became part of the cryptocurrency ledger.

The disclosed system presents a data management system for data provenance and data storage that allows multiple independent parties (who may not trust each other) to securely share data, track data provenance, maintain audit logs, keep data synchronized, comply with regulations, handle permissioning, and control who can access the data. The system leverages the security guarantees deriving from the computer systems already trusted to control billions of dollars' worth of Bitcoin and Ethereum cryptocurrencies to create a secure and completely auditable system of document tracking that can be shared among untrusted parties over a computer network. The system works both with public cryptocurrency ledgers (for the purposes of this disclosure immutable cryptocurrency ledgers are referred to as merely “blockchains”), like Bitcoin and Ethereum, and with private blockchains.

In this description, references to “an embodiment,” “one embodiment” or the like mean that the particular feature, function, structure or characteristic being described is included in at least one embodiment introduced here. Occurrences of such phrases in this specification do not necessarily all refer to the same embodiment. On the other hand, the embodiments referred to also are not necessarily mutually exclusive.

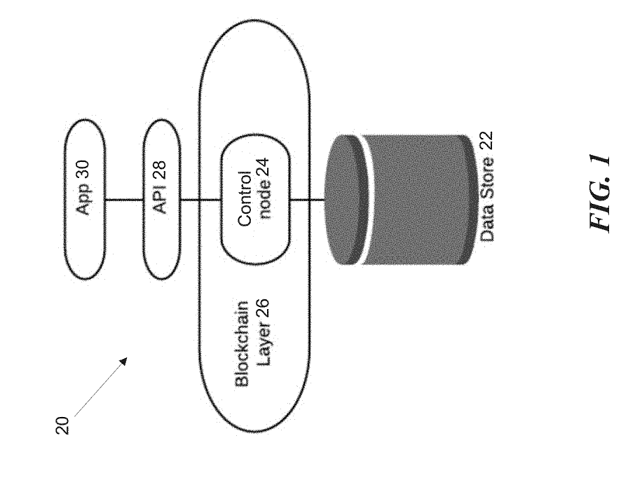

FIG. 1 is an illustrative block diagram of a single-entity system architecture 20. The underlying data store 22 can be an existing data store (i.e., Amazon Web Services S3 or a file server or database) on top of which a control node 24 can run and provide additional functionality. The control node 24 in the blockchain layer 26 and API 28 component is the core of the system architecture 20.

The API 28 and the control node 24 are software components installed as machine-level, software gateways to the data stores 22. Custom user supplied applications integrate with the API 28. Even though these components are installed at each machine, it is unnecessary for there to be a coordinating backend server. However, in some embodiments, there is additionally a backend server to push updates to the control nodes 24 and APIs 28.

The application/entity 30 component can be any software application built on top of this system that needs to store and retrieve the data, or retrieve the data provenance and audit trails. Applications 30 that can run on this system include: various analytics apps to visualize data provenance, permissions, data access, regulatory and compliance apps to provide auditing and verification capabilities, and machine learning applications. For the purposes of this disclosure, the terms “application” and “entity” are nearly interchangeable. Each refers to a software application, a party that operates that software application, or a party that acts in the interest of that software application.

The API component 28 is a software interface that interfaces with the app 30 (or user) and supports commands for data storage and retrieval, and changes the permissions of access control for the data. The API 28 communicates the commands to the control node 24. The control node 24 connects to the blockchain network (or networks, possibly more than one, and possibly both public, like Bitcoin and Ethereum, or private/permissioned, like an intra-company blockchain) and to the data store 22. The control node 24 enforces the permissions and access to the data in the data store 22 and creates the audit trail for data provenance, permission changes, and all app 30 (or user) actions. The audit trail and permissions are stored in the data store 22, and they are also stored or hashed into the blockchain layer 26 to prove the correctness of the audit trail and permissions. The original file content data is only stored in the data store 22. Metadata, hashes of the data, permissions or hashes thereof, and the commands are written to the blockchain via the control node 24.

The control node 24 interfaces with a blockchain that may support programmable smart contracts. Smart contracts may be used in a preferred embodiment to implement any subset of functionality. Zero, one, or more than one smart contracts may be utilized to provide data services via blockchain. In a preferred embodiment, one smart contract is used for data provenance and another smart contract is used for recording data ownership and permissioning.

When data is stored in the data store 22, the hash of the data, owner of the data, and the data permission is written to the blockchain along with hashes of any source data for data provenance. The actor or actors responsible for this writing may include one or more smart contracts on the blockchain itself or an external network service process.

When the data is to be retrieved, a smart contract or external network service process may be used to check if the retriever has permission to access the data. If so, then access is granted to the data on the data store 22. This access is also recorded in the blockchain. If access is not allowed, that is also written to the blockchain.

When data is updated, similar to retrieval, first the permissions are checked with the smart contract. If the permission exists, then the hash of the updated data and the source of the data (provenance) is written in the blockchain.

As established above, the blockchain contains an immutable audit log of all the activity. This component is significant in the system because unlike centralized data provenance solutions, the logs and execution of contracts in the blockchain do not require trusting any single party. Multiple untrusted parties are together ensuring that the data on the blockchain is correct. Blockchains such as Ethereum support public and private keys for doing cryptographic signatures. The control node 24 can use the native addresses based on public keys in that blockchain as the mapping to users in the system 20. Authentication of a user is performed via the algorithm that the blockchain uses by cryptographic signatures using the user's key.

The data store 22 can be any existing data store such as AWS S3, Google Cloud Storage, Microsoft Azure Storage, Box.com, an independent file server, or a single laptop. The data store 22 can also be a distributed data store such as IPFS (InterPlanetary File System) or a distributed database. The appropriate interface in the control node 24 interfaces with each type of data store 22. This has the advantage that existing data stores 22 may continue to be used within the system 20. Different types of data stores 22 can be used in the same system, and even though they each have different interfaces, the API 28 provides a common interface to all the data stores 22.

In some embodiments, for efficiency, the file content data is stored off the blockchain in the data store 22. Hashes of the data and permissions and the audit log (reads and writes to data on the data store 22) are stored on the blockchain. This provides privacy of the file content data as well as increased efficiency for scalability.

Using this scheme, there may still result a large amount of data that must be stored on the blockchain. Some blockchains, such as the Bitcoin blockchain, only tolerate seven transactions a second (across the entire network). Further, blocks are appended to the block chain on average of 10-15 minutes at a time. To increase privacy and scalability, the system 20 switches to anchoring hash chains and Merkle trees to the blockchain, and move some operations off the main chain of the blockchain to a side chain.

In some embodiments, a blockchain layer 24 uses a hybrid approach including both a public and a private blockchain. In this manner, a private blockchain is used for the majority of recordable events (e.g., reads, writes, access control, or provenance). Using a private blockchain, the time between block posting may be reduced, and the system 20 may use a greater percentage of the blockchain's total transactions per second constraint. After a certain period (e.g., 10 minutes), all of the recordable events on the private chain are hashed into a single batch/aggregate encoded transaction on the public blockchain. In this manner, the system 20 leverages both the security of a public blockchain and the speed of a private blockchain.

The system 20 described above enables a number of new abilities: for the single party that is running this system, the party may prove that the data, data provenance, and permissions in their data store 22 are correct without needing to trust their own records. Conversely, if someone within tampered with their data, it can be spotted because the blockchain audit trail would not match. For tampering to work, the blockchain must also be compromised which would require a coordinated compromise of numerous independent parties, an unlikely and much more expensive scenario. Security monitoring can be done by creating an alert if the local hashes no longer match the blockchain hashes, as this would indicate a fault or attack.

With respect to data access control, various users within a single application 30 may have different permissions. In this manner, the control node 24 may generate embedded transactions in the blockchain layer 26 that include specific data access control permissions for the various user profiles of the application 30.

In order to coordinate between the control node 24 and the blockchain layer 26, the control node may operate a number of accounts on the blockchain layer 26 with each account in the blockchain layer 26 having a public and private account key. In some embodiments, at least some of the account keys (public and private) are provided to users of the application 30 as a means to login to the system 20 and authenticate identity in order to facilitate data access control and audit log purposes. The account keys (public and private) may be stored in the data store 22. The control node 24 freely accesses the data store 22 for administrative data requests. Such administrative requests do not necessarily have to be recorded in the audit log.

In some embodiments, at least some of the account keys (public and private) remain as inaccessible data within the control node 24. The account keys pertain to no particular user or application and are created for the purposes of record keeping. For example, one set of account keys (public and private) of the blockchain layer 26 may be used by the control node 24 on behalf of a group of users of the application 30 to store data access control permissions for the whole group. In another example, a given set of account keys may pertain specifically to a subset of data within the data store 22. It is unnecessary for any actual user to directly access these accounts; thus, the control node 24 performs all handling of such accounts.

Alternatively, in some embodiments, a given control node 24 maintains a single blockchain account and embeds all necessary data access control, provenance, and audit log details in transactions with the single account.

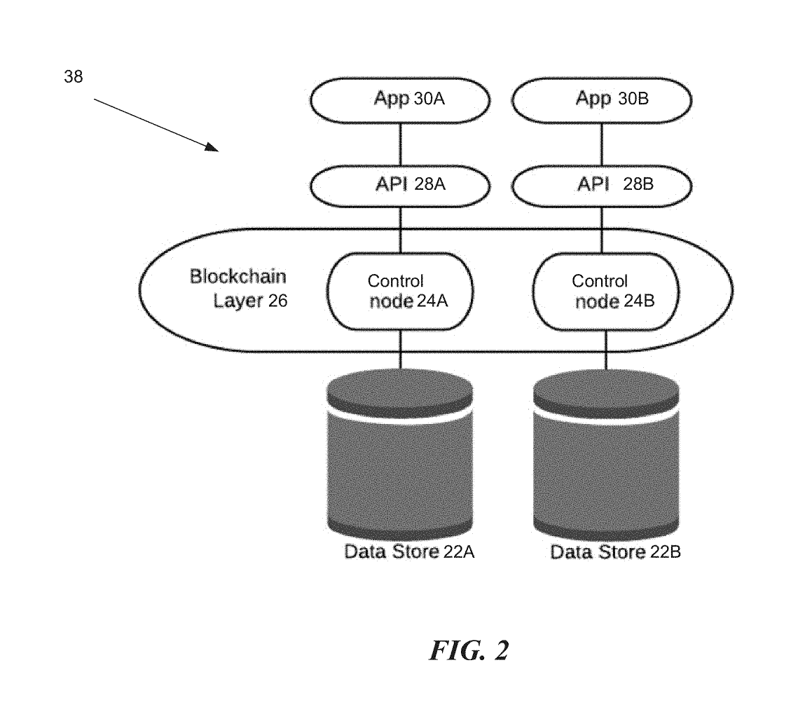

FIG. 2 is an illustrative block diagram of a dual-entity system architecture 38. The dual-entity system 38 includes two entities or applications 30A, 30B each running respective data stores 22A, 22B. Each application 30A, 30B can share data with the other and prove the provenance of the data to one another without trusting the other.

Data within this system maintains clear data provenance and permissions. This is performed via the blockchain layer 26 and the corresponding control nodes 24A, 24B similarly as in FIG. 1. Permissions can be revoked to prevent future user access to the data while maintaining the custodial chain. The chain of custody can be traced multiple hops to all the previous data owners. The chain of custody enables functionality for monetization of data. As a result that all data owners are known via the blockchain layer 26, data can be sold and a portion of the sales can be allocated to all previous data owners.

Shared data via the data stores 22A, 22B is available to parties that have permission via queries of the respective API 28A, 28B. An API 28A handles the queries by communicating with a local control node 24A. The local control node 24A corresponds with a partner control node 24B via the blockchain layer 26. Assuming the local control node 24A has permission to query the partner control node 24B, then control node 24B will communicate with the data store 22B and forward requested data back through the chain to entity/application 30A.

Shared duplicate data between two parties is kept in synchrony with each data store 22A, 22B by monitoring the data provenance of each. If there is any update to either data copy, an optional alert is sent to the other party about the data update.

In some embodiments of the system, data storage and retrieval is structured in terms of a POSIX compliant filesystem layer. This provides out-of-the-box compatibility with most other standard open- and closed-source computer software without custom software development work.

The control nodes 24A, 24B in the dual-entity system 38 support different blockchain protocols (e.g., Bitcoin, Ethereum, Ripple, etc.) and can connect to both public and private blockchains. The advantage of connecting to a public blockchain (e.g., Bitcoin or Ethereum) is that it allows the dual-entity system to be secure even where there are relatively few users (in the dual-entity system 38 there are only two users). As a result that public cryptocurrencies are used for other applications, there are many other users in the block chain layer 24 that do not interact with the control nodes 24A, 24B, but still provide overall security for the public blockchain.

For example, when a small party needs to work with a much larger party, often the larger party has the power to change the history of the interaction in their favor. Using the blockchain layer 26, that is not possible because the data provenance and audit trail is secured by a much larger network (e.g., Bitcoin).

In order to coordinate between the control node 24A, control node 24B and the blockchain layer 26, the control nodes 24A, 24B may operate a number of accounts on the blockchain layer 26. This operates similarly as discussed with reference to FIG. 1 with the added complexity that blockchain accounts are held by different control nodes 24A, 24B. In some embodiments, each control node 24A, 24B shares the public keys of accounts it respectively controls, but keeps the private keys private. Thus, transactions with embedded audit log data are generated between accounts controlled by control nodes 24A, 24B; however, it is still unnecessary for the entities 30A, 30B to trust one another even between the operation of their respective control nodes 24A, 24B as the private keys (or private data within the data store 22) are not shared with the other.

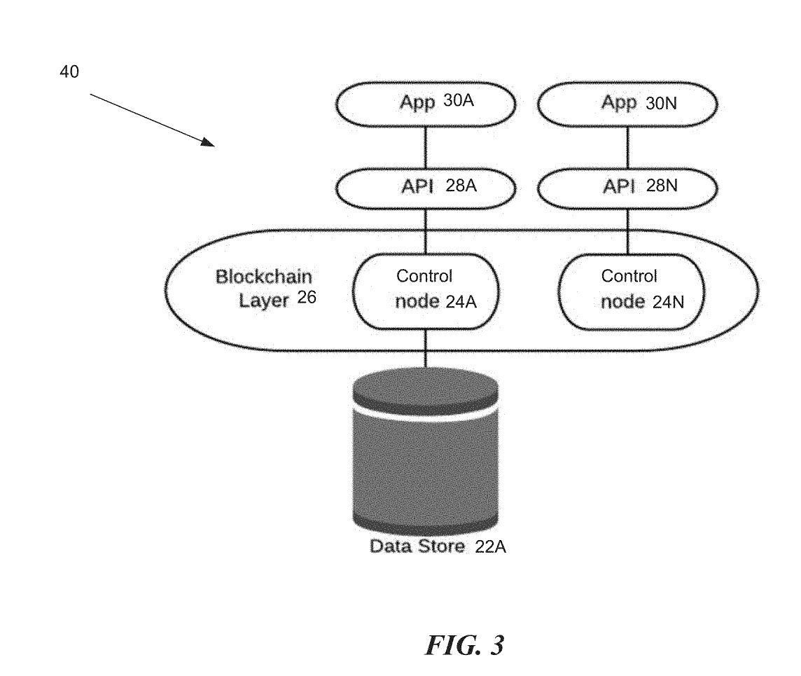

FIG. 3 is an illustrative block diagram of a multi-entity system architecture 40 with a single data store. In this configuration, there is an entity/application 30A that has an associated data store 22A, and one or more other entities 30N that are communicatively coupled to within the multi-entity system 40. There are a number of circumstances where such a configuration occurs. One such example is where a given entity/application 30N performs a compliance role and uses the multi-entity system 40 to monitor the data of the first entity 30A in data store 22A in order to ensure compliance.

In another example, the data store 22A is a cloud storage server and entity 30N is the data owner. In this example, entity 30N is using the data store 22A of entity 30A as a data store for resident applications. In a reverse example, entity 30A is the owner of the data and shares the data to application 30N to execute functions on the data.

In the case where entity 30A is the owner of the data and entity 30N is using the data in an application, entity 30A may monetize the data usage directly via payments using the cryptocurrency of the blockchain layer 24 based on tracked and permissioned data usage. Entity 30A may provide a benefit for entity 30N using entity 30A's data (e.g., training an AI model for entity 30N). In this multi-party data sharing case, the data from data store 22A may contain Personally Identifiable Information (PII) which cannot be shared. The PII data can be stripped out via control node assigned permissions and only non-PII data is shared. A third party can participate by running a compliance node as described in another example earlier and monitor that no PII data is shared.

Artificial Intelligence (AI) has made huge achievements in recent years. Examples include self-driving cars, image understanding, and speech recognition. One key factor for the success is that today AI has the capability to process massive data and utilize those data to decrease error rates to pass the success baseline. However, most of the AI applications today utilize the training data to train the model through a centralized and controlled environment. The multi-entity system architecture 40 enables controlled sharing of this information.

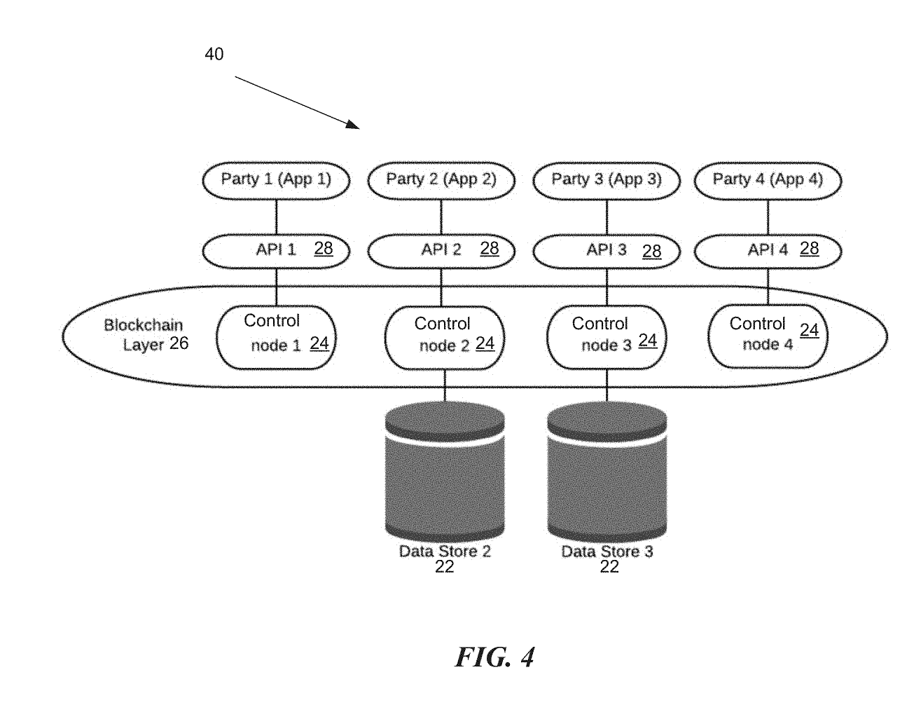

FIG. 4 is an illustrative block diagram of a multi-entity system architecture with a multiple data stores. The multi-entity system 40 is highly scalable. There may be any number of entities each with or without corresponding data stores. Each entity includes a respective API and a control node. The multi-entity system 40 further scales to adapt to multiple cryptocurrency protocols, and thus may communicate with multiple blockchains simultaneously.

Previously discussed were the security features of a large public cryptocurrency protocol. Conversely, when thousands of participants are using the multi-entity system 40, the users may either slow down a public blockchain, like Bitcoin, or request more transaction throughput that is otherwise available. In this respect, transaction refers to recordable events (e.g., reads, writes, edits, synchronizations, provenance, permissions, etc.) on the blockchain as opposed to monetary transactions. Despite this, public cryptocurrency protocols are simultaneously used for monetary transactions as well. Bitcoin handles seven transactions per second (this limit is established by the block generation rate and the block size limits, and is subject to change). With a sufficiently sized multi-entity system 40, this rate may not be fast enough. Additionally, the multi-entity system 40 may cause issues for native blockchain features.

As a result, the thousands of participants can use their own private cryptocurrency blockchains that operate on a faster pace than Bitcoin. Further, because there are thousands of participants, this network is also secure against attacks by any small subset of parties. In this manner, the private cryptocurrency can be controlled for block size and block rate (thus leading to more than seven transactions per second, and faster than 10-15 minutes per block).

In some embodiments, the multi-entity system 40 may also make use of a hybrid cryptocurrency model where two or more cryptocurrencies are used. For example, the private cryptocurrency blockchain can also be anchored to a public blockchain and gain the security of both. To anchor, hashed data of the transactions on the private blockchain may be embedded to a single transaction on the public blockchain. For example, this anchoring may occur once per block on the public blockchain (e.g., once every 10-15 minutes).

For several parties who are sharing data with each other using the multi-entity system 40, another way to achieve faster transaction times is to use a State Channel. The control nodes 24 create a single State Channel for all the parties, and any time any entity has an update to their data store 22, that entity updates the State Channel with a new hash value of their hash chain. The State Channel allows all other entities with permission to get the hash updates quickly, and the hash updates are secure because the latest hash chains all previous hashes, and any entity can write the latest hash to the Blockchain.

Additional reasons for supporting many cryptocurrency protocols are that different cryptocurrencies have different desirable properties. Some have better privacy properties. User regulations may forbid public cryptocurrencies from being used. Cryptocurrencies have different consensus mechanisms and some may develop forks in the chain, which may be undesirable, while others disallow forks by design. Some cryptocurrency protocols are based on Proof-of-Work, which may be quite wasteful, so the control nodes 24A, 24B are additionally configured to communicate with non-Proof-of-Work cryptocurrency blockchains.

In some embodiments, the multi-entity system 40 may provide a systematic way to allow different parties to share information and train AI models using the right data over the entire world. The proposed data management system utilizes blockchain technology to provide a public environment that engages different parties to share data and train AI models. For example, where one entity is a machine learning expert and other entities are data providers that have massive data with different information, the machine learning expert generates an application that uses training for a machine learning model and does not have enough domain knowledge or data. This party finds other parties and requests the data service to perform the task.

In this example, the multi-entity system 40 can provide data access control via commands provided via an API 28 to a control node 24 and let the machine learning expert access the necessary data. The machine learning expert is able to take that data, transform it into training data, and feed the data to the machine learning models. Additionally, there may be another type of entity who performs model/data validation to make sure the machine learning expert used the right data to train the model. Those service providers may be paid by utilizing the natural payment functionality in the blockchain layer 26.

The multi-entity system 40 provides clear data provenance for the AI models that were trained. The control nodes 24 generate transactions to the blockchain layer 24 that embed the audit logs for exactly whose data was provided to train the AI models. This process creates a virtual marketplace that allows AI/machine learning service and data sharing to be transacted in a secure and distributed environment among many parties.

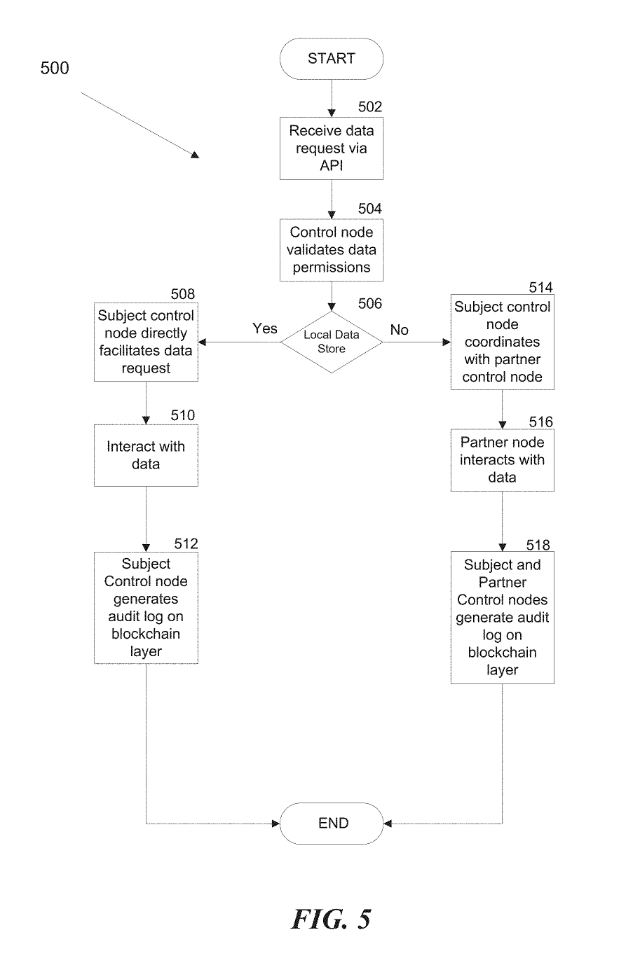

FIG. 5 is a flowchart illustrating control nodes facilitating data requests. In step 502, the API receives a data request from application. The data request may be a rule change, to amend data access control policies; a query, to read data from a data store; or an insertion or edit, to write data to the data store. The data request will include identity. The identity may be of the application, a user of the application, or a group of users of the application.

In step 504, the control node verifies data access control permissions based on the identity of the data request. The data access control permissions are stored in the blockchain layer, in data embedded in transactions. Where the application or the application user does not have permission to access the data, control node denies access. In step 506, the control node determines where the relevant data for the data request is located. The data may be in the data store managed by the current, subject control node, or the data may be in a data store managed by a partner control node.

Where the data resides on the local data store, in step 508, the subject control node directly facilitates the data request in the data store. In step 510, the subject control node interacts with the data based on application or application user commands, and restricts, reads, writes, or creates data in the data store. In step 512, the subject control node generates an audit log on the blockchain layer of the data interaction. When new data is created, data provenance details are included in the audit log.

Where data resides in another data store, in step 514, the subject control coordinates with a partner control node that manages the other data store. This may include queries from the subject control node to the partner control node concerning data access control permissions. In step 516, the partner control node interacts with the data in the data store. The partner control note interaction is based on instructions from the application or user of the application similarly to step 510.

In step 518, the subject and partner control nodes together have generated audit logs on the blockchain layer. In some embodiments, a single log is created for both control nodes. In other embodiments, each control node creates its own respective audit log on the blockchain layer.

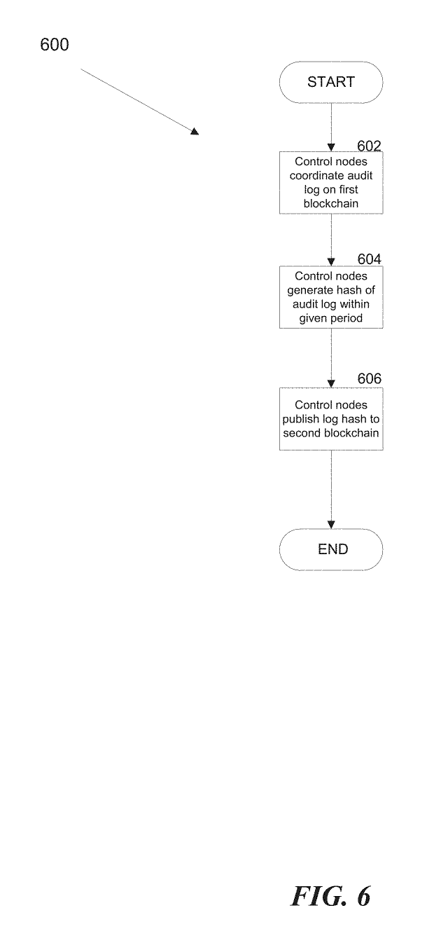

FIG. 6 is a flowchart illustrating blockchain hybridization. In step 602, control nodes work in singular or in cooperation maintaining audit logs on a first blockchain. The audit logs in response to application or user instructions interacting with data stores. The audit logs of recordable events are embedded within transactions on the first blockchain as each individually occurs. Based on operation of the first blockchain, blocks are appended as blockchain protocol dictates despite the rate of recordable events embedded into transactions.

In step 604, control nodes periodically generate a single hash of multiple recordable events that occurred within a given period. These recordable events have been included within an audit log already recorded on the first blockchain. In step 606, the control nodes embed the hash of the multiple recordable events into a transaction on the second Blockchain. In this manner, events of the first blockchain are anchored to the second blockchain thereby leveraging the security of both the first and second blockchains.

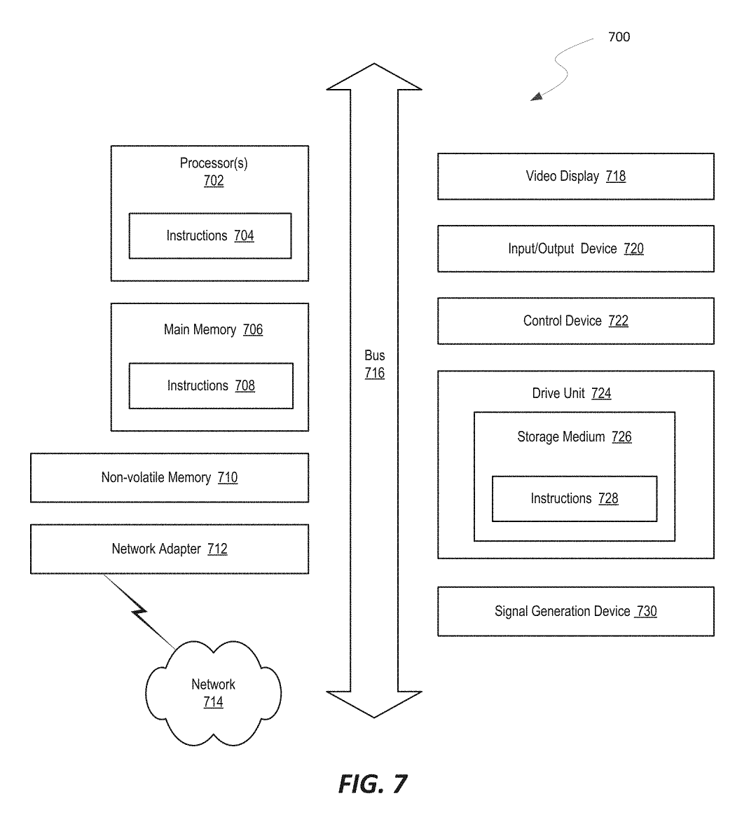

FIG. 7 is a block diagram illustrating an example of a computing system 700 in which at least some operations described herein can be implemented. The computing system may include one or more central processing units (“processors”) 702, main memory 706, non-volatile memory 710, network adapter 712 (e.g., network interfaces), video display 718, input/output devices 720, control device 722 (e.g., keyboard and pointing devices), drive unit 724 including a storage medium 726, and signal generation device 730 that are communicatively connected to a bus 716. The bus 716 is illustrated as an abstraction that represents any one or more separate physical buses, point-to-point connections, or both connected by appropriate bridges, adapters, or controllers. The bus 716, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the computing system 700 operates as a standalone device, although the computing system 700 may be connected (e.g., wired or wirelessly) to other machines. In a networked deployment, the computing system 700 may operate in the capacity of a server or a client machine in a client-server network environment, or as a peer machine in a peer-to-peer (or distributed) network environment.

The computing system 700 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by the computing system.

While the main memory 706, non-volatile memory 710, and storage medium 726 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 728. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure may be implemented as part of an operating system or a specific application, component, program, object, module or sequence of instructions referred to as “computer programs.” The computer programs typically comprise one or more instructions (e.g., instructions 704, 708, 728) set at various times in various memory and storage devices in a computer, and that, when read and executed by one or more processing units or processors 702, cause the computing system 700 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices 710, floppy and other removable disks, hard disk drives, optical disks (e.g., Compact Disk Read-Only Memory (CD-ROMS), Digital Versatile Disks, (DVDs), Blu-Ray disks), and transmission type media such as digital and analog communication links.

The network adapter 712 enables the computing system 700 to mediate data in a network 714 with an entity that is external to the computing device 700, through any known and/or convenient communications protocol supported by the computing system 700 and the external entity. The network adapter 712 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 712 can include a firewall, which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list, which details permissions including for example, the access and operation rights of an object by an individual, a machine, and/or an application, and the circumstances under which the permission rights stand.

Other network security functions can be performed or included in the functions of the firewall, can include, but are not limited to, intrusion-prevention, intrusion detection, next-generation firewall, personal firewall, etc.

The techniques introduced herein can be embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical disks, compact disk read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for data access control to a data store by an application comprising:
restricting access to make data requests to the data store based upon the existence of an authorization record on an immutable cryptocurrency ledger, the authorization record encoded to a first cryptocurrency transaction on the immutable cryptocurrency ledger;
verifying the existence of the authorization record on the immutable cryptocurrency ledger in response to a data request of the data store by a requestor; and
facilitating the data request between the data store and the requestor.

2. The method of claim 1, further comprising:
upon receiving instructions from a user, issuing the authorization record by encoding hashed data to the first cryptocurrency transaction on the immutable cryptocurrency ledger.

3. The method of claim 1, said verifying further comprises:
determining that the authorization record enables authorization to request only a subset of data on the data store; and
wherein said facilitating the data request delivers only the subset of data to the requester.

4. The method of claim 1, further comprising:
restricting access to make data writes to the data store based upon the existence of a writing authorization record on the immutable cryptocurrency ledger, the writing authorization record encoded to the first cryptocurrency transaction on the immutable cryptocurrency ledger;
verifying the existence of the writing authorization record on the immutable cryptocurrency ledger in response to a write request to the data store by a first user; and
facilitating the write request between the data store and the first user.

5. The method of claim 4, further comprising:
forwarding a first data item with write instructions to the data store from a first user;
generating a write record on the immutable cryptocurrency ledger, the write record is encoded to a second cryptocurrency transaction on the immutable cryptocurrency ledger and includes a timestamp and identifying information for the first user.

6. The method of claim 1, said facilitating further comprising:
generating a read record on the immutable cryptocurrency ledger, the read record is encoded to a second cryptocurrency transaction on the immutable cryptocurrency ledger and includes a timestamp and identifying information for the requester.

7. The method of claim 1, further comprising:
recording on the immutable cryptocurrency ledger in a plurality of encoded transactions each read, write, and authorization status for the data store, each encoded transaction of the plurality of encoded transactions including a timestamp and identifying metadata for relevant users.

8. The method of claim 7, wherein each encoded transaction of the plurality of encoded transactions further comprises metadata describing any of:
data read;
data modified;
data created; or
a changelog of modifications of data.

9. The method of claim 7, wherein the immutable cryptocurrency ledger is a subchain immutable ledger, and the method further comprising:
periodically recording to a public immutable cryptocurrency ledger data included in each of the encoded transactions on the subchain immutable ledger occurring since a previous periodic recording into one batch encoded transaction on the public immutable cryptocurrency ledger.

10. The method of claim 1, wherein the requester is authenticated for data access control using native cryptocurrency features of a private key associated with the requester.

11. The method of claim 1, said facilitating further comprising:
processing a payment by the requester in response to fulfillment of the data request.

12. A system for data access control by an application comprising:
a data store accessible over the Internet;
a computer node corresponding with the data store and an immutable cryptocurrency ledger, the computer node programmed to restrict access to the data store based upon the existence of an authorization record on the immutable cryptocurrency ledger, the authorization record encoded to a first cryptocurrency transaction on the immutable cryptocurrency ledger, the computer node further programmed to verify the existence of the authorization record on the immutable cryptocurrency ledger in response to a data request of the data store by a requestor and to facilitating that data request between the data store and the requestor.

13. The system of claim 12, wherein the computer node is further programmed to record on the immutable cryptocurrency ledger in a plurality of encoded transactions each read, write, and authorization status for the data store, each encoded transaction of the plurality of encoded transactions including a timestamp and identifying metadata for relevant users.

14. The system of claim 13, wherein each encoded transaction of the plurality of encoded transactions further comprises metadata describing any of:
data read;
data modified;
data created; or
a changelog of modifications of data.

15. The system of claim 12, wherein the computer node programming to verify of the authorization record includes determining that the authorization record enables authorization to access only a subset of data on the data store.

16. A method for data access control to a data store by an application comprising:
generating, at a first gateway node, an access request for the data store, the first gateway node communicatively coupled with a data processor and an immutable cryptocurrency ledger;
transmitting the access request over the Internet to a second gateway node, the second gateway node communicatively coupled with the immutable cryptocurrency ledger and the data store;
verifying, by the second gateway node, access restrictions for the first gateway node to the data store, the access restrictions based upon the existence of an authorization record on the immutable cryptocurrency ledger, the authorization record encoded to a first cryptocurrency transaction on the immutable cryptocurrency ledger; and
enabling access, by the second gateway node, to the data store for the data processor through the first gateway node in response to said verification by the second gateway node.

17. The method of claim 16, wherein the data processor is a machine learning or AI application, and the data store contains training data.

18. The method of claim 17,
generating a read record on the immutable cryptocurrency ledger, the read record is encoded to a second cryptocurrency transaction on the immutable cryptocurrency ledger and includes a timestamp and identifying information for the data store to indicate origin of the training data.

19. The method of claim 16, further comprising:
issuing, by the second gateway node, the authorization record for the first gateway node by encoding hashed data to a second cryptocurrency transaction on the immutable cryptocurrency ledger.

20. The method of claim 18, wherein the data store is a second data store and said issuing is conditioned on:
issuing, by the first gateway node, a reciprocal authorization record for the second gateway node by encoding hashed data to a third cryptocurrency transaction on the immutable cryptocurrency ledger, the reciprocal authorization record enables access for the second gateway node to a first data store to communicatively coupled to the first gateway node.
